(19) United States
(12) Patent Application Publication
(10) Pub. No.: US 2003/0213326 A1
(43) Pub. Date: Nov. 20, 2003

(54) Cable-operated transmission shifters

(76) Inventors: Brian W. Fett, Norton Shores, MI (US); Nathan J. Schout, Holland, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/430,782

(22) Filed: May 6, 2003

Related U.S. Application Data
(60) Provisional application No. 60/380,571, filed on May 14, 2002.

(51) Int. Cl. B60K 20/00

(52) U.S. Cl. 74/473.3; 74/473.34

(57) ABSTRACT

A manual transmission shifter includes a shift lever pivotally supported on a base for multi-axial pivoting movement, and a bell crank pivotally supported on the base and operatively connected to the shift lever by a pivot/slide connection. Two cables are operatively attached to the shift lever and the bell crank, respectively, for shifting the transmission. A pivot/slide connection includes an aperture in the bell crank with grooves, a bushing operably mounted in the grooves for both linear sliding and rotational movement on the grooves, and an arm on the shift lever that telescopingly engages the bushing. A top cover compresses the flat spring between the top cover and the socket. The shift lever includes arms that attach to bushing blocks, which engage the flat spring so that when the shift lever is pivoted in the one direction, the associated opposing portion of the spring(s) biases the shift lever back toward a centered position.

This application claims benefit of provisional application filed under 37 C.F.R. 1.53(c), including provisional application Serial No. 60/380,571, filed May 14, 2002, entitled CABLE-OPERATED TRANSMISSION SHIFTERS.

### BACKGROUND

The present invention relates to cable-operated transmission shifters, and more particularly relates to a shifter adapted for shifting a transmission through use of cables. The present shifter has simplified components for efficient assembly, and includes a bell crank operably coupled to the shift lever by a novel universal joint for operating a telescoping transmission shift cable.

In many vehicles, shifters are positioned directly over their manual transmission, so that the shift lever extends downwardly directly into a transmission. This makes connection of the shift lever to the manual transmission relatively easy. For example, see Olmsted U.S. Pat. No. 5,313,853. However, the shifters in many new “smaller” vehicles are forced by styling and other constraints to a position that is not aligned with the transmission, such that it is not possible to mount the shifter directly over its transmission shift mechanism. This misalignment leads to a variety of different shifter constructions, such as the transmission-cable shifters shown in Osborn U.S. Pat. No. 5,651,290 and Osborn U.S. Pat. No. 4,245,521 (reissued as Pat. No. RE 31,451). However, the shifters disclosed in U.S. Pat. Nos. '290 and '521 have many pieces, making them more expensive to manufacture and assemble than is desired. It is desirable to provide a shifter having substantially fewer pieces, lower cost components, and that is easier to assemble, while still maintaining durability and robustness of the shifter.

Manual shifters include a shift lever pivotable in “x-y” directions (i.e. in a fore/aft “y” direction and in a transverse or sideways “x” direction), and further often include a bent-wire spring for biasing the shift lever to a centered position relative to the sideways “x” direction. (For example, see spring 74 in FIGS. 1 and 8 in Pat. No. Re 31,451.) They also usually include additional bent-wire springs for providing different biasing forces in the shifters, such as to provide a detented feel and to eliminate noise. (See springs 60 and 67 in FIG. 1 of Pat. No. Re 31,451.) However, bent-wire springs have disadvantages in that, due to their bent shape, they have greater dimensional variation than is desired, they are more difficult to pull apart, orient, and assemble than is desired, their biasing forces and torque curves may vary more than desired (and the forces may vary over time), and they can be undesirably affected by mechanical friction as they rotate with the moving member (unless adequate lubricant is provided and maintained over time, which can be a problem).

The manual shifter shown in U.S. Pat. No. 5,313,853 uses flat biasing springs (12) to bias its shift lever to a central position. However, the shifter of U.S. Pat. No. '853 is only adapted to mount directly to the manual transmission that it engages. The shifter of U.S. Pat. No. '853 is not a cable-operated shifter. There is no provision in the shifter of U.S. Pat. No. '853 to operably engage and operate a bell crank for telescopingly moving a cable to shift a transmission when the shift lever is pivoted along the sideways “x” direction.

The Osborn '290 patent discloses a manual shifter where its base includes a molded socket that is mounted atop a sheet metal weldment, and a shift lever with ball engages the socket for pivotally mounting the shift lever on the base. The U.S. Pat. No. '290 does not disclose its biasing spring, but it is noted that a bent-wire spring is mounted on the pivot pin 68 for biasing the bell crank (69) to a centered position, which in turn biases the shift lever (22) to its centered position. Despite the existence of the prior art shown in U.S. Pat. Nos. 5,651,290, Re 31,451 (i.e. U.S. Pat. Nos. 4,245,521, and 5,313,853), no one ever contemplated or conceived of combining the flat biasing springs of U.S. Pat. No. 5,313,853 into a shifter base structure of a cable-operated shifter, as has been done in the present invention.

Another more subtle problem occurs at a connection of the bell crank to a shift lever. The shift lever includes a lateral arm that extends into sliding/rotational contact with a leg of the bell crank. When the shift lever is moved sideways, the shift lever moves about a first horizontal axis that extends forwardly, but the bell crank rotates about a second horizontal axis that extends cross car (i.e. perpendicular to the first horizontal axis). The result is that when the bell crank rotates, it drags the sliding/rotational contact along a non-planar “vertical” arc. The “vertical” arc is primarily a vertical motion, but has a non-planar component. The result is that the arm from the shift lever is forced to move along the curvilinear arc, and in turn, the shift lever itself is forced to move forwardly as it is moved side to side.

It is noted that in some prior art pivot/slide joints, a ball is mounted within a bore in a manner that allows the ball to both slide and simultaneously rotate within the bore. For example, see the joint of items 4 and 14 in Great Britain patent GB 979,574, published Jan. 6, 1965. The present inventors believe that this arrangement is generally not acceptable for a pivot/slide joint in a shifter, for the following reasons. When a pivot/slide joint consists of a ball slidably and rotatably positioned in a bore, it results in a line contact of the ball against the surface of the bore. This line contact results in wear, since stresses are focused at the line of contact, which soon leads to excessive wear and sloppiness of the pivot/slide connection. Further, the initial assembly is often sloppy and loose, since the exacting tolerances required on the ball and on the bore for said line contact are difficult to control to an adequately tight level that provides both adequate rotation and sliding movement without binding, and at the same time adequate tightness. Notably, when the interfitting ball and bore are not sufficiently tight, they “immediately” cause looseness and sloppiness, which results in the shift lever being “sloppy” and having a poor feel. If the ball and bore are too tight, they drag and bind, also causing poor feel. Notably, the line contact soon results in early wear on the ball, which causes an assembly that was initially “good” to become sloppy.

Accordingly, an apparatus solving the aforementioned problems and having the aforementioned advantages is desired.

### SUMMARY OF THE PRESENT INVENTION

In one aspect of the present invention, a shifter for shifting a vehicle transmission includes a base, a shift lever pivotally supported on the base for multi-axial pivoting movement, and a bell crank pivotally supported on the base. A first actuator is operatively attached to the shift lever for shifting a transmission, and a second actuator is operatively attached to the bell crank for shifting the transmission. A pivot/slide connection connects the shift lever to the bell crank, and includes an aperture in the bell crank having a pair of parallel grooves, and further includes a bushing operably mounted in the groove for both sliding movement along the grooves and rotation about an axis parallel the grooves, and still further includes an arm that extends from the shift lever telescopingly into engagement with the bushing.

In another aspect of the present invention, a shifter for shifting a vehicle transmission includes a base including a socket, a shift lever including a ball section engaging the socket and pivotally supported on the base for multi-axial pivoting movement, and a bell crank pivotally supported on the base. The shift lever includes an arm engaging the bell crank for rotating the bell crank when the shift lever is pivoted in a first direction. A first actuator is operatively attached to the shift lever for shifting a transmission when the shift lever is pivoted in a second direction perpendicular to the first direction, and a second actuator is operatively attached to the bell crank for shifting the transmission when the shift lever is pivoted in the first direction. A top cover is attached to a top of the base, and at least one flat spring is held between the top cover and the socket. The shift lever includes arms that engage bushing blocks which engage opposing portions of the flat spring and that bend the associated opposing portion when the shift lever is pivoted in the first direction, such that the associated opposing portion biases the shift lever back toward a centered position after being pivoted in the first direction away from the centered position.

In another aspect of the present invention, a shifter is provided for mounting in a vehicle, with the vehicle defining a fore/aft direction, a transverse horizontal direction, and a vertical direction, with the fore/aft direction and the transverse horizontal direction defining a fore/aft/vertical plane, and with the transverse horizontal direction and the vertical direction defining a transverse vertical plane. The shifter includes a molded base adapted for attachment to a vehicle, and includes a socket-defining section. The shift lever includes a ball section rotatably engaging the socket for rotational movement parallel the fore/aft/vertical plane and also for rotational movement parallel the transverse/vertical plane. The shift lever also includes a leg with a first universal connector adapted for engaging a first transmission cable, and includes a laterally-extending arm. A bell crank is pivotally supported on a side of the molded base, and includes a first leg engaging the arm at a pivot/slide connection, and includes a second leg with a second universal connector adapted for engaging a second transmission cable. The pivot/slide connection includes a bushing that slidably engages a free end of the arm in a direction parallel a length of the arm, and linearly slidably engages grooves in the bell crank for linear movement parallel the fore/aft/vertical plane and that also rotatably engages the grooves for rotational movement about an axis that extends parallel the grooves. By this arrangement, when the shift lever is pivoted along a first path parallel the fore/aft/vertical plane, the first universal connector moves in a manner adapted to shift the first transmission cable, and the second universal connector is not moved to change its location. Also by this arrangement, when the shift lever is pivoted along a second path parallel the transverse/vertical plane, the first universal connector does not move in the fore/aft direction, but the second universal connector moves in a manner adapted to shift the second transmission cable, and with the free end sliding within the bushing, and the bushing sliding along the grooves, and the bushing rotating about the axis parallel the grooves.

In yet another aspect of the present invention, a shifter is provided for mounting in a vehicle, the vehicle defining a fore/aft direction, a transverse horizontal direction, and a vertical direction, with the fore/aft direction and the transverse horizontal direction defining a fore/aft/vertical plane, and with the transverse horizontal direction and the vertical direction defining a transverse vertical plane. The shifter includes a molded base adapted for attachment to a vehicle, and includes a socket-defining section and a spring-engaging support extending around the socket-defining section. The shift lever includes a ball section rotatably engaging the socket for rotational movement parallel the fore/aft/vertical plane and also for rotational movement parallel the transverse/vertical plane. The shift lever also includes a leg with a first universal connector adapted for engaging a first transmission cable, and including a laterally-extending arm. A bell crank is pivotally supported on a side of the molded base by a pivot pin, and includes a first leg engaging the arm at a pivot/slide connection, and includes a second leg with a second universal connector adapted for engaging a second transmission cable. A washer-shaped flat spring engages the spring-engaging up surface, and a cover is attached to the top of the molded base. The cover includes two bottom surfaces that engage at least one flat spring and that pretensions the flat spring against the spring-engaging up surface. Bushing blocks on the arm engage the flat spring when the shift lever is pivoted parallel the transverse/vertical plane so that flexure of the spring biases the shift lever toward a centered position, with the bushing blocks being located at a central area such that the bushing blocks do not flex the spring when the shift lever is pivoted parallel the fore/aft/vertical plane.

As noted above in the background section, in some prior art arrangements of pivot/slide joints, a ball is mounted within a bore in a manner that allows the ball to both slide and simultaneously rotate within the bore. For example, see the joint in items 4 and 14 in Great Britain patent GB 979,574, published Jan. 6, 1965. The present inventors believe that this is generally not acceptable for a pivot/slide joint in a shifter, for the following reasons. When a pivot/slide joint consists of a ball slidably and rotatably positioned in a bore, it results in a line contact of the ball against the surface of the bore. This line contact results in wear, since stresses are focused at the line of contact, which soon leads to excessive wear and sloppiness of the pivot/slide connection. Further, the initial assembly is often sloppy and loose, since tolerances on the ball and on the bore are difficult to control to a tight level that provides both adequate rotation and sliding movement without binding, and at the same time adequate tightness. Notably, when the interfitting ball and bore are not sufficiently tight, they “immediately” cause looseness and sloppiness, which results in the shift lever being “sloppy” and having poor feel. If the ball and bore are too tight, they drag and bind, also causing a poor feel. Notably, the line contact soon results in wear, which causes an assembly that was initially “good” to become sloppy. The present inventive arrangement overcomes this problem by providing a large surface area on all inter-engaging bearing surfaces, including between the pin end 28 and bushing 42, between the bushing 42 and the grooves 44 for rotational support, and along the bushing 42 and the grooves 44 for linear sliding support, as discussed below.

These and other aspects, objects, and features of the present invention will be understood and appreciated by those skilled in the art upon studying the following specification, claims, and appended drawings.

### BRIEF DESCRIPTION OF DRAWINGS

FIG. 1 is an exploded perspective view of a shifter embodying the present invention;

FIG. 1A is an enlarged fragmentary view of the pivot/slide joint shown in FIG. 1;

FIG. 1B is an exploded view similar to FIG. 1, but at a different angle;

FIGS. 2-7 are left side, right side, rear, front, top, and bottom views of the shifter assembly of FIG. 1, FIGS. 6 and 7 being a base and part of a shift lever;

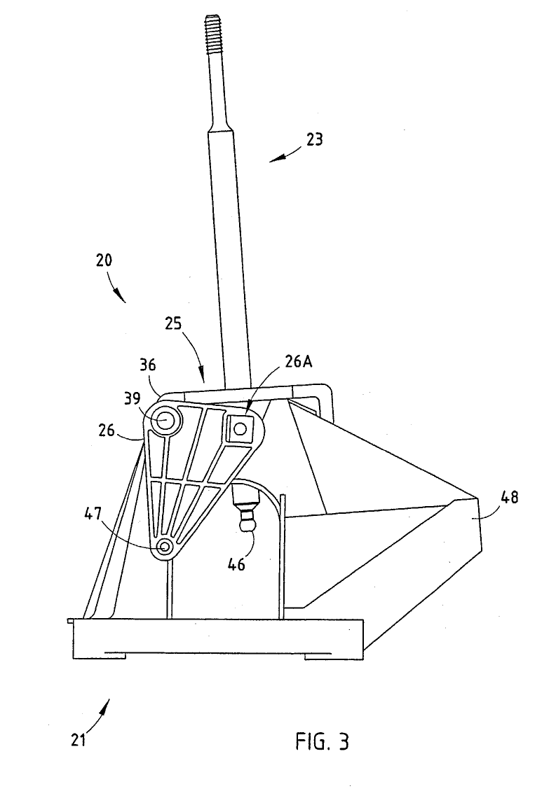

FIGS. 8-13 are perspective, top, front, left side, right side cross section, and bottom views of the base shown in FIG. 1, FIG. 12 being a cross section;

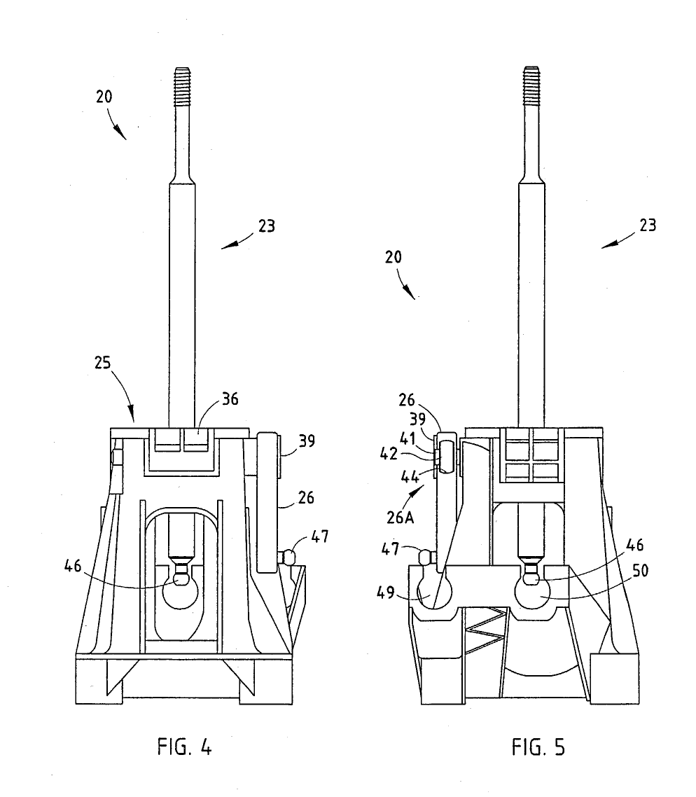

FIG. 14 is a cross section taken along the line XIV in FIG. 9;

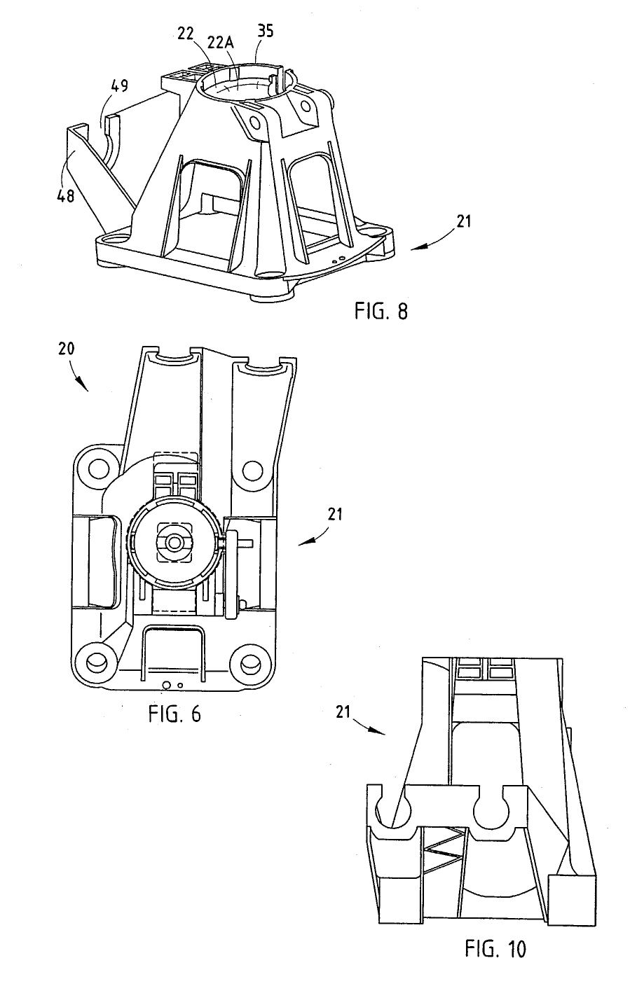

FIGS. 15-17 are top, side, and back views of the lever assembly shown in FIG. 1;

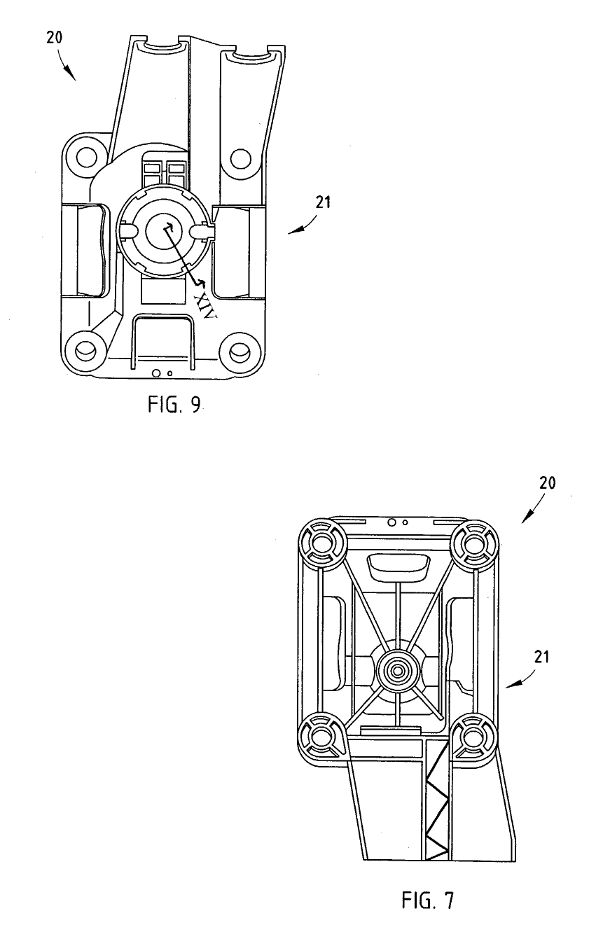

FIGS. 18-19 are fragmentary views of the shift lever post and a top section of the shift lever post;

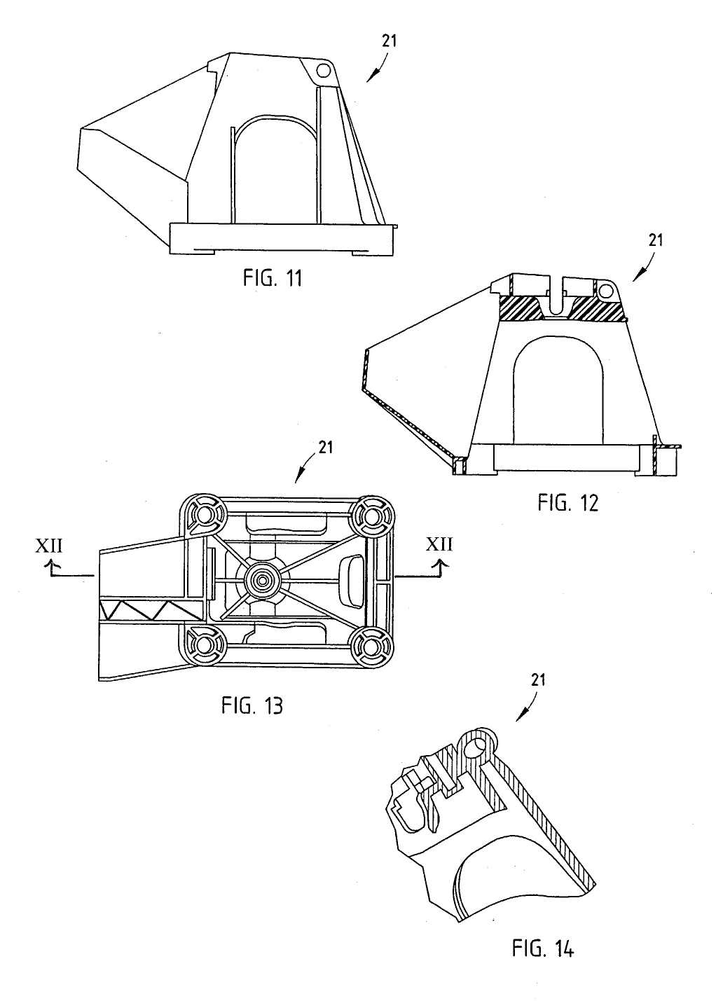

FIGS. 20-21 are side and front views of the shifter, with the shift lever pivoted to the driver side (U.S.) such that the bell crank is pivoted to a raised position, and such that the bushing of the pivot/slide joint is oscillated linearly along the grooves in the bell crank (see arrow, FIG. 20) and is rotated (see the small arrow on the bushing, FIG. 21); and

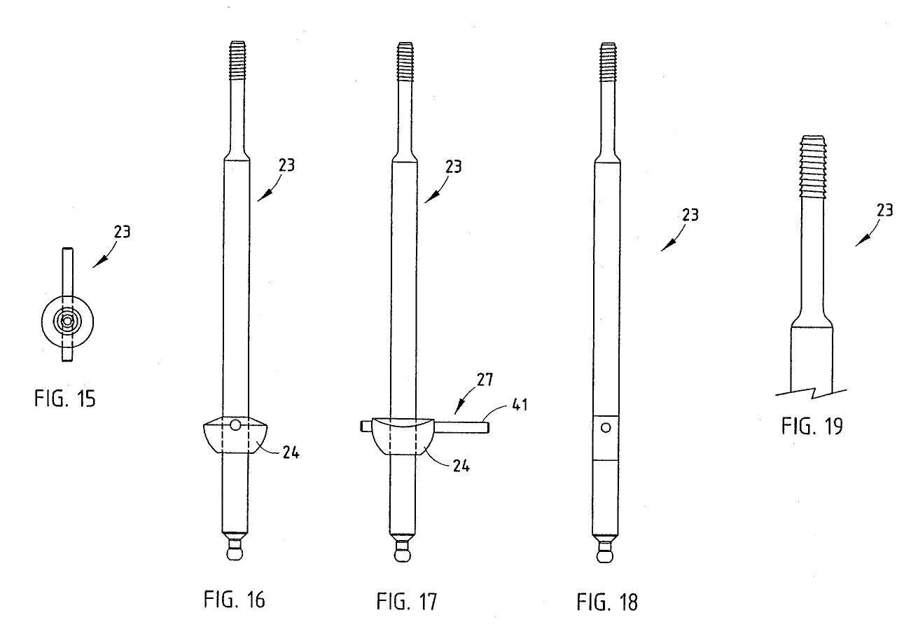

FIGS. 22-23 are side and front views of the shifter, with the shift lever pivoted to the passenger side (U.S.) such that the bell crank is pivoted to a lowered position, and such that the bushing of the pivot/slide joint is oscillated linearly along the grooves in the bell crank (see arrow, FIG. 22) and is rotated (see small arrow on the bushing, FIG. 23).

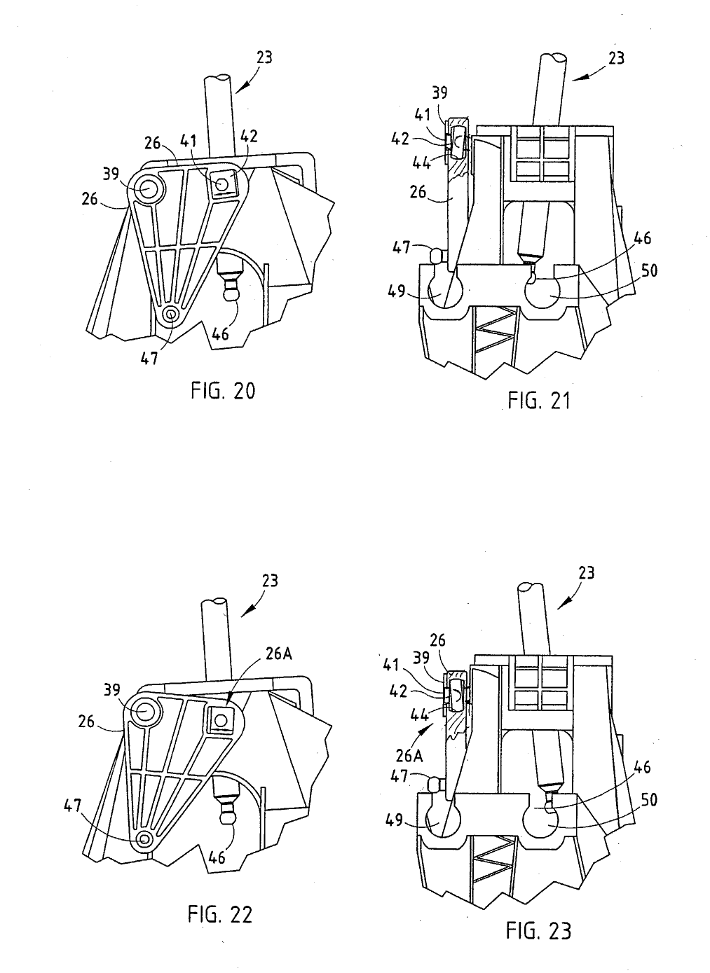

### DETAILED DESCRIPTION OF PREFERRED EMBODIMENTS

The present shifter 20 is a two-cable manual shifter adapted for shifting a manual transmission in a vehicle. The shifter 20 utilizes one or more washer-shaped flat springs 32 which reduces cost and further incorporates fewer components that provide a simple and durable assembly that is easily put together, thus providing considerable cost-effectiveness.

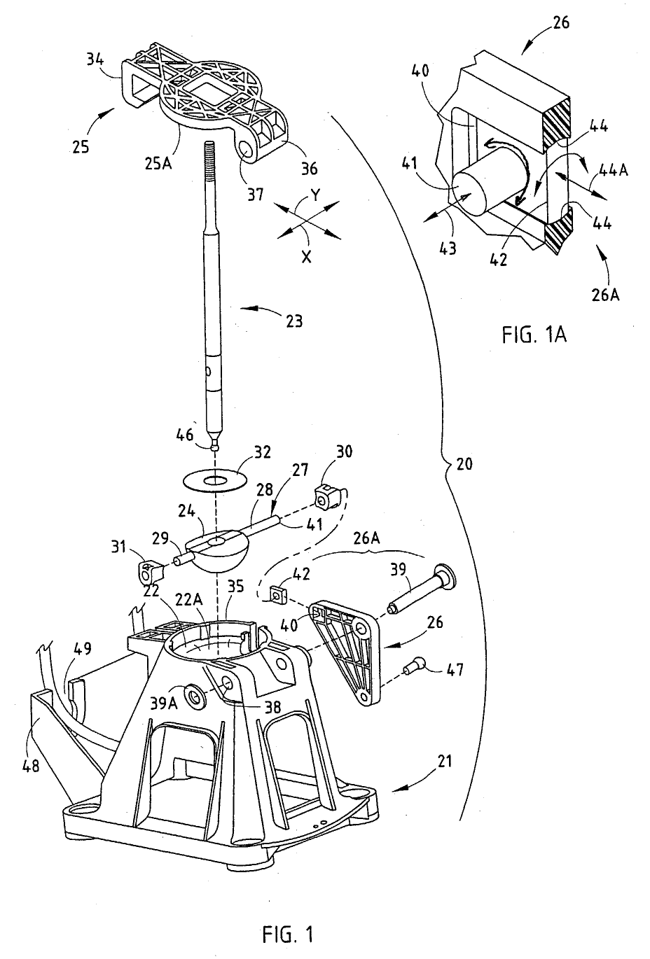

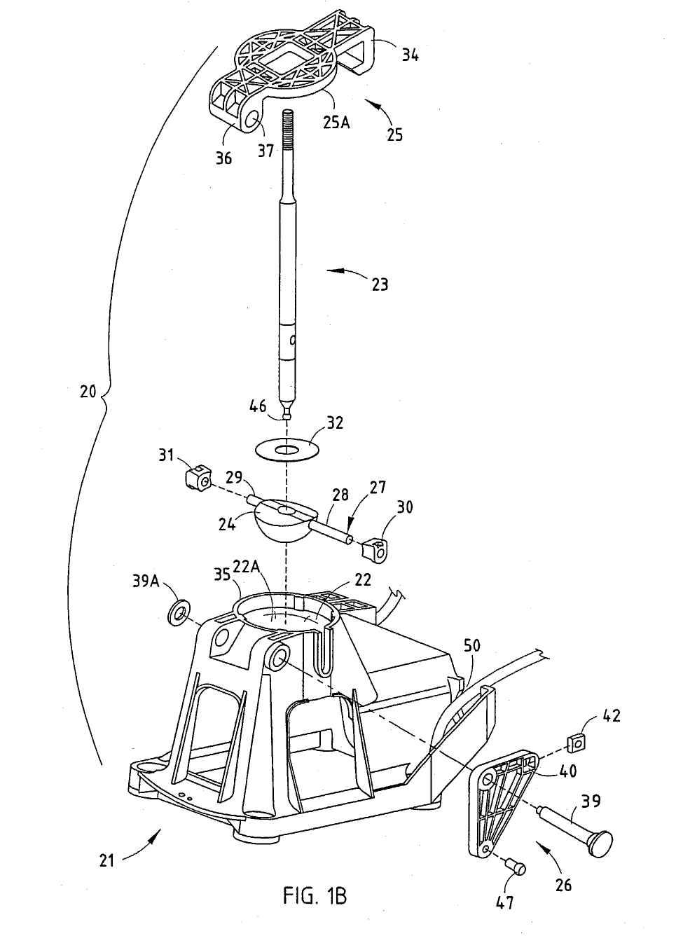

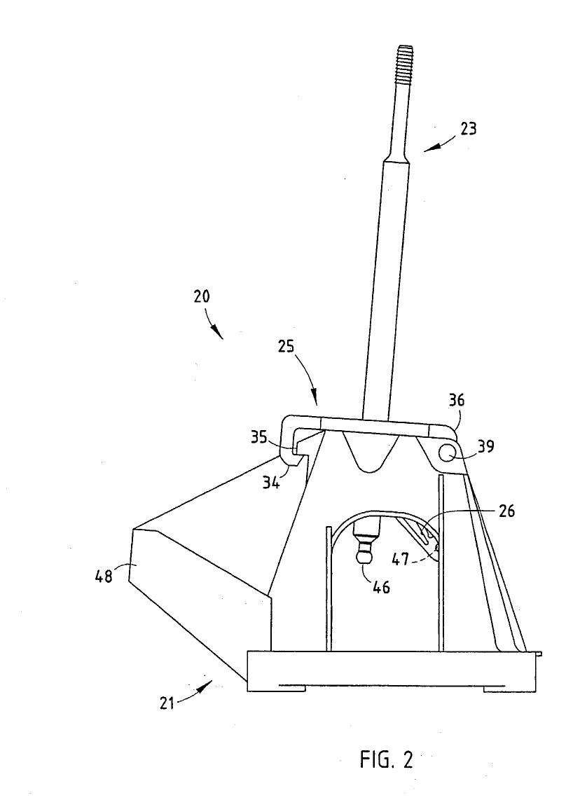

More specifically, the present shifter 20 (FIG. 1) includes a housing/base 21 defining an up-facing socket 22, a shift lever 23 having a ball section 24 that fits into the socket 22, and a top cap 25 that holds the ball section 24 in the socket 22 while allowing multi-axial rotation (i.e. x-y pivoting movement) of the lever 23. The shift lever 23 includes a transverse pin 27 that has opposite ends or arms 28 and 29 that extend from the ball section 24. A centerline formed by the arms extends through a center point of the ball section 24, such that rotation of the shift lever 23 fore-to-aft will not cause the arms 28 and 29 to bend the spring 32. Also, the top surface of the ball section 24 is angled so that opposing tips of the edges of the top surface of the ball section 24 lie in plane that contains the axis of the arms 28 and 29, which helps the spring 32 to provide a bias force only when desired. The ends 28 and 29 include bushing blocks 30 and 31. One or more flat washer-shaped springs 32 (see description in U.S. Pat. No. 5,313,853) are trapped between an “up” facing support structure forming the perimeter surface 22A in the socket 22 of the base 21 and the bottom surface 25A of the top cap 25, with the ends 28 and 29 also engaging the bushing blocks which engage the bottom of the spring(s) 32. The supports 22A and 25A bend the springs 32 during assembly and hold the spring(s) 32 in a pre-stressed bowed condition, in an arrangement that is not unlike that shown in U.S. Pat. No. 5,313,853, the entire contents of which are incorporated herein in their entirety.

When the lever 23 is pivoted sideways in an “x” direction, one of the pin ends 28 and 29 is lifted and moves its respective block (30 or 31) into engagement with the springs 32 to bend the springs 32 in a manner that causes springs 32 to bias the lever 23 back to a centered home position. When the lever 23 is pivoted in a fore/aft “y” direction, neither foot 30 nor 31 is lifted, and hence the springs 32 do not provide a biasing force. Notably, the directions of movement of the lever 23 are more clearly defined as follows relative to a vehicle-mounted position and orientation. The “y” direction is a fore/aft direction. The “x” direction is a sideways or transverse direction. The vertical direction is “up”. The “y” and vertical directions define a fore/aft/vertical plane, in which the shift lever 23 moves when pivoted in the “y” direction, such as for shifting from neutral into a gear position (such as 1st gear, 2nd gear, etc). The “x” and vertical directions define a transverse/vertical plane, in which the shift lever 23 moves when pivoted in the “x” direction, such as for moving the shift lever 23 from one end to another end of its neutral position. The shift lever 23 is biased by the springs 32 when moved in the sideways “x” direction, but not when moved in the fore/aft “y” direction.

The cover 25 includes one end 34 that hooks laterally into engagement with a mating ledge 35 on the housing base 21, and further includes a second end 36 having a transverse hole 37 that aligns with holes 38 in the housing/base 21. A pivot pin 39 extends through the holes 37 and 38, and serves to hold the cover 25 on the housing/base 21. An end of the pivot pin 39 extends outwardly from the cover 25 and serves to mount on the bell crank 26, as noted below. A center section of the top cap 25 forms a “belly” that extends across between the ends 34 and 36. The “belly” of the top cap 25 is bowed slightly, so that the cover 25 is engaged and pre-stressed with sufficient force against the up surface on the housing/base 21. This also counteracts the tendency of the plastic material of the cover to creep and hence cause a loss of strength to tension the bowed spring(s) 32. The underside of the cover has two protrusions along the centerline of the cover. The protrusions are positioned in front and behind the square lever through hole of the cover. These protrusions preload the spring, giving it a curved shape. A bell crank 26 is pivotally supported on an outer end of the pivot pin 39, and is held thereon by a retainer nut 39A.

The bell crank 26 is coupled to the shift lever 23 by a no-slop, long-wearing pivot/slide joint assembly 26A. The pivot/slide joint assembly 26A is believed to be novel, useful, non-obvious, and potentially very important, and comprises the following features. The bell crank 26 includes a rectangular notch or aperture 40 that receives an outwardly extended outer tip 41 of the pin end 28. A bushing 42 is slidably positioned on the outer tip 41 for allowing the pin end 28 to telescopingly move axially in a direction 43 (FIG. 1A) parallel to a length of the pin end 28 and also for allowing rotational movement of the bushing 42 on the pin end 28. The aperture 40 includes parallel linear grooves 44 that extend in a direction perpendicular to the direction 43. The grooves 44 are linear, but have a cross-sectional shape (i.e. in the direction 43) of a circle, with their radius being equal to a distance from their bearing surface to the centerline of the pin end 28. This arrangement allows the bushing 42 to slide linearly along the grooves 44 in a direction 44A parallel a length of the grooves 44, and also allows the bushing 42 to rotate within the grooves 44 about an axis that extends parallel a length of the grooves, the axis being located exactly between the grooves and extending parallel the grooves. By this arrangement, the bushing can slide along the grooves 44, and can simultaneously rotate within the grooves 44, and allow the pin end 28 to telescopingly slide inside the bushing 42.

This arrangement provides the following advantages. 1) The pin end 28 slides linearly within the bushing 42 when the shift lever 23 is pivoted side-to-side (i.e. in the sideways direction “x”) and causes the bell crank 26 to also pivot, and the bushing provides a large bearing surface for the pin end 28 (which large bearing surface is much better than a bearing surface that provides only a “line contact”). 2) The bushing 42 slides along the grooves 44 in a linear fore/aft motion when the shift lever 23 is pivoted side-to-side and the bell crank 26 is pivoted, and also the bushing 42 rotates within the grooves 44 a few degrees about an axis that extends parallel the grooves 44, such that even though the pivot/slide joint 26A moves in an arc about the crank pivot pin 39, the pivot/slide joint 26A is able to accommodate all positions of the shift lever 23 and the bell crank 26 . . . and is still able to provide a large bearing contact area (i.e. the bushing 26 has a large contact area on grooves 44, and does more than merely provide a line contact).

The shift lever 23 (FIG. 1) includes a first universal connector 46, and the bell crank 26 includes a second universal connector 47. The housing/base 21 includes a mounting flange 48 having a first “U” aperture 49 and a second “U” aperture 50. A first cable 51 (FIG. 1B) (e.g. a Bowden transmission cable) includes an internal cable attached to connector 46, with its sheath 52 attached to the “U” aperture 49, and a second cable includes an internal cable 53A attached to the connector 47, and its sheath to the “U” aperture 50. It is contemplated that a rod or link could be used in place of the cable.

The components of the present shifter are relatively inexpensive to manufacture, and very inexpensive to assemble, and further the assembly includes relatively and surprisingly few major components. The arrangement provides a significant advantage in cost savings, assemblability, and durability over known competing shifters.

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. A shifter for shifting a vehicle transmission comprising:
a base;
a shift lever pivotally supported on the base for multi-axial pivoting movement;
a bell crank pivotally supported on the base;
a first actuator operatively attached to the shift lever for shifting a transmission;
a second actuator operatively attached to the bell crank for shifting the transmission;
a pivot/slide connection connecting the shift lever to the bell crank, including an aperture in the bell crank having a pair of parallel grooves, and further including a bushing operably mounted in the groove for both sliding movement along the grooves and rotation about an axis parallel the grooves, and still further including an arm that extends from the shift lever telescopingly into engagement with the bushing.

2. The shifter defined in claim 1, wherein the bell crank includes a wall section having a thickness, and wherein the parallel grooves extend perpendicular to the thickness of the wall section.

3. The shifter defined in claim 2, wherein the bushing includes edges engaging the parallel grooves, the grooves having a surface defining opposing sides of a cylindrical shape, and the edges defining a diameter matching the cylindrical shape for rotatably engaging the grooves.

4. The shifter defined in claim 3, wherein the arm comprises a rod having a diameter that slidingly engages a mating hole in the bushing.

5. The shifter defined in claim 4, wherein the bushing comprises a flat rectangular washer-like member.

6. The shifter defined in claim 1, wherein the base defines a first set of spring supports and includes a cover defining a second set of spring supports, and further including a plate spring captured between the first and second sets of spring supports and biased to a bowed condition, the shift lever including spring-engaging bushing blocks that engage opposing portions of the spring when the shift lever is pivoted about an axis that extends generally perpendicular to the arms to pivot the shift lever back to a center position.

7. The shifter defined in claim 6, including a pivot pin that attaches the cover to the base, the pivot pin operably supporting the bell crank.

8. The shifter defined in claim 7, wherein the cover includes a hook opposite the pivot pin that attaches to a mating ledge on the base, such that the cover is attached by the hook and pivot pin.

9. The shifter defined in claim 1, wherein the first and second actuators include cables attached to first and second universal connectors on the shift lever and bell crank, respectively.

10. A shifter for shifting a vehicle transmission comprising:
a base including a socket;
a shift lever including a ball section engaging the socket and pivotally supported on the base for multi-axial pivoting movement;
a bell crank pivotally supported on the base, the shift lever including an arm engaging the bell crank for rotating the bell crank when the shift lever is pivoted in a first direction;
a first actuator operatively attached to the shift lever for shifting a transmission when the shift lever is pivoted in a second direction perpendicular to the first direction;
a second actuator operatively attached to the bell crank for shifting the transmission when the shift lever is pivoted in the first direction;
a top cover attached to a top of the base;
at least one flat spring held between the top cover and the socket, the shift lever including arms that engage bushing blocks which engage opposing portions of the flat spring and that bend the associated opposing portion when the shift lever is pivoted in the first direction, such that the associated opposing portion biases the shift lever back toward a centered position after being pivoted in the first direction away from the centered position.

11. The shifter defined in claim 10, including a pivot/slide connection that operably interconnects the arm to the bell crank, the pivot/slide connection including a bushing that slidably and rotatably engages the arm and that slidably and rotatably engages the bell crank.

12. The shifter defined in claim 11, wherein the bell crank includes a wall section having a thickness and including an aperture for receiving the bushing, the aperture being defined in part by a pair of parallel grooves extend perpendicular to the thickness of the wall section, the bushing rotatably and slidingly engaging the grooves.

13. The shifter defined in claim 12, wherein the bushing includes edges engaging the parallel grooves, the grooves having a surface defining opposing sides of a cylindrical shape, and the edges defining a diameter matching the cylindrical shape for rotatably engaging the grooves.

14. The shifter defined in claim 13, wherein the arm is a rod having a diameter that slidingly engages a mating hole in the bushing.

15. The shifter defined in claim 10, wherein the base defines a first set of spring supports and includes a cover defining a second set of spring supports, the flat spring being captured between the first and second sets of spring supports and biased to a bowed condition.

16. The shifter defined in claim 10, including a pivot pin that attaches the cover to the base, the pivot pin operably supporting the bell crank.

17. The shifter defined in claim 16, wherein the cover includes a hook opposite the pivot pin that attaches to a mating ledge on the base, such that the cover is attached by the hook and pivot pin.

18. The shifter defined in claim 10, wherein the first and second actuators include cables attached to first and second universal connectors on the shift lever and bell crank, respectively.

19. A shifter for mounting in a vehicle, the vehicle defining a fore/aft direction, a transverse horizontal direction, and a vertical direction, with the fore/aft direction and the transverse horizontal direction defining a fore/aft/vertical plane, and with the transverse horizontal direction and the vertical direction defining a transverse vertical plane, the shifter comprising:
a molded base adapted for attachment to a vehicle, and including a socket-defining section;
a shift lever including a ball section rotatably engaging the socket for rotational movement parallel the fore/aft/vertical plane and also for rotational movement parallel the transverse/vertical plane, the shift lever including a leg with a first universal connector adapted for engaging a first transmission cable, and including a laterally-extending arm;
a bell crank pivotally supported on a side of the molded base, and including a first leg engaging the arm at a pivot/slide connection, and including a second leg with a second universal connector adapted for engaging a second transmission cable;
the pivot/slide connection including a bushing that slidably engages a free end of the arm in a direction parallel a length of the arm, and that linearly slidably engages grooves in the bell crank for linear movement parallel the fore/aft/vertical plane and that also rotatably engages the grooves for rotational movement about an axis that extends parallel the grooves;
whereby, when the shift lever is pivoted along a first path parallel the fore/aft/vertical plane, the first universal connector moves in a manner adapted to shift the first transmission cable, and the second universal connector is not moved to change its location;
whereby, when the shift lever is pivoted along a second path parallel the transverse/vertical plane, the first universal connector does not move in the fore/aft direction, but the second universal connector moves in a manner adapted to shift the second transmission cable, and including the free end sliding within the bushing, and the bushing sliding along the grooves, and the bushing rotating about the axis parallel the grooves.

20. A shifter for mounting in a vehicle, the vehicle defining a fore/aft direction, a transverse horizontal direction, and a vertical direction, with the fore/aft direction and the transverse horizontal direction defining a fore/aft/vertical plane, and with the transverse horizontal direction and the vertical direction defining a transverse vertical plane, the shifter comprising:
a molded base adapted for attachment to a vehicle, and including a socket-defining section and including a spring-engaging set of supports around the socket-defining section;
a shift lever including a ball section rotatably engaging the socket for rotational movement parallel the fore/aft/vertical plane and also for rotational movement parallel the transverse/vertical plane, the shift lever including a leg with a first universal connector adapted for engaging a first transmission cable, and including a laterally-extending arm;
a bell crank pivotally supported on a side of the molded base by a pivot pin, and including a first leg engaging the arm at a pivot/slide connection, and including a second leg with a second universal connector adapted for engaging a second transmission cable;
at least one washer-shaped flat spring engaging the spring-engaging up surface; and
a cover attached to a top of the molded base, the cover including a bottom surface that engages the flat spring and that pretensions the flat spring against the spring-engaging up surface; and
block bushings on the arm that engage the flat spring when the shift lever is pivoted parallel the transverse/vertical plane so that flexure of the spring biases the shift lever toward a centered position, the block bushings being located near the central area such that the block bushings do not flex the spring when the shift lever is pivoted parallel the fore/aft/vertical plane.
